(19) United States
(12) Patent Application Publication
(10) Pub. No.: US 2019/0103063 A1
(43) Pub. Date: Apr. 4, 2019

(54) DISPLAY SUBSTRATE, DISPLAY DEVICE AND DRIVING METHOD THEREOF

(71) Applicants: BEIJING BOE DISPLAY TECHNOLOGY CO., LTD., Beijing (CN); BOE TECHNOLOGY GROUP CO., LTD., Beijing (CN)

(72) Inventors: Sha LIU, Beijing (CN); Yun QIU, Beijing (CN)

(21) Appl. No.: 16/132,779

(22) Filed: Sep. 17, 2018

(30) Foreign Application Priority Data
Sep. 29, 2017 (CN) 201710910859.X

(51) Int. Cl. G09G 3/36; G02F 1/1335; G02F 1/1343

(52) U.S. Cl. CPC G09G 3/36; G02F 1/133514; G02F 1/133512; G02F 1/133553; G02F 1/134309

(57) ABSTRACT

A display substrate, a display device and a driving method thereof are provided. The display substrate includes a plurality of pixel regions, a plurality of non-pixel regions, and a plurality of optical sensing units located in the plurality of non-pixel regions, each of the plurality of non-pixel regions being located between adjacent pixel regions, each of the plurality of optical sensing units being configured to receive light and output a sensing signal.

### CROSS-REFERENCE TO RELATED APPLICATION

The application claims priority to the Chinese patent application No. 201710910859.X, filed on Sep. 29, 2017, the entire disclosure of which is incorporated herein by reference as part of the present application.

### TECHNICAL FIELD

At least one embodiment of the present disclosure relates to a display substrate, a display device and a driving method thereof.

### BACKGROUND

More and more new functions such as fingerprint recognition and optical sensor are integrated into display products such as smartphones, tablets and notebook computers. The pixels per inch (PPI) of a display screen in the display product is also constantly improved to meet the ever-increasing display demand.

### SUMMARY

At least one embodiment of the present disclosure relates to a display substrate, a display device and a driving method thereof, which can improve transmittance without reducing an aperture ratio of a sub-pixel.

At least one embodiment of the present disclosure provides a display substrate, comprising: a plurality of pixel regions, a plurality of non-pixel regions, and a plurality of optical sensing units located in the plurality of non-pixel regions, each of the plurality of non-pixel regions being located between adjacent pixel regions, each of the plurality of optical sensing units being configured to receive light and output a sensing signal.

In some embodiments, the optical sensing unit comprises a photosensitive layer configured to absorb the light.

In some embodiments, the display substrate further comprises a first base substrate and a reflection layer, wherein the reflection layer and the plurality of optical sensing units are disposed on the first base substrate; the reflection layer is configured to reflect light irradiated thereon and located in the plurality of non-pixel regions; and the plurality of optical sensing units are closer to the first base substrate than the reflection layer.

In some embodiments, the reflection layer comprises a plurality of reflection elements; and an area of a cross-section of each of the reflection elements in a direction parallel with the first base substrate is gradually decreased in a direction from a position close to the first base substrate to a position away from the first base substrate.

In some embodiments, a cross-section of each of the reflection elements in a direction perpendicular to the first base substrate comprises a curved or parabolic part.

In some embodiments, the reflection layer comprises a plurality of reflection elements; and in a direction perpendicular to the first base substrate, an area of a cross-section parallel with the first base substrate of each of the reflection elements close to the first base substrate is greater than an area of a cross-section parallel with the first base substrate of the reflection element away from the first base substrate.

In some embodiments, the reflection layer comprises a plurality of reflection elements; and a distance between adjacent reflection elements is gradually increased in a direction from a position close to the first base substrate to a position away from the first base substrate.

In some embodiments, the reflection layer and the plurality of optical sensing units are at least partially overlapped with each other in a direction perpendicular to the first base substrate.

In some embodiments, the plurality of optical sensing units are in a one-to-one correspondence with the plurality of pixel regions.

In some embodiments, the display substrate further comprises a first base substrate and a color filter (CF) layer, wherein the plurality of optical sensing units and the CF layer are disposed on the first base substrate, and the CF layer is located on a side of the plurality of optical sensing units close to the first base substrate.

At least one embodiment of the present disclosure further provides a display device, comprising a second base substrate and any one of the display substrates as described above, wherein the second base substrate is disposed opposite to the display substrate; and a plurality of mutually insulated display electrodes are further provided on a side of the second base substrate close to the display substrate.

In some embodiments, each of the optical sensing units corresponds to at least one display electrode.

In some embodiments, the display device further comprises a signal receiving unit, a signal adjusting unit and a signal outputting unit, wherein the signal receiving unit is configured to receive the sensing signal; the signal adjusting unit is configured to adjust a first driving signal, to be inputted into the display electrode of the pixel region to which the optical sensing unit outputting the sensing signal belongs, into a second driving signal according to the sensing signal; and the signal outputting unit is configured to input the second driving signal to the display electrode.

At least one embodiment of the present disclosure further provides a method for driving a display device, the display device comprising a second base substrate and a display substrate; the display substrate comprising: a plurality of pixel regions, a plurality of non-pixel regions and a plurality of optical sensing units; each of the plurality of non-pixel regions being located between adjacent pixel regions; the plurality of optical sensing units being located in the plurality of non-pixel regions; each of the plurality of optical sensing units being configured to receive light and output a sensing signal; the second base substrate being disposed opposite to the display substrate; a plurality of mutually insulated display electrodes being further provided on a side of the second base substrate close to the display substrate; the method comprising: receiving the sensing signal outputted by the optical sensing unit; adjusting a first driving signal, to be inputted into the display electrode of the pixel region to which the optical sensing unit outputting the sensing signal belongs, into a second driving signal according to the sensing signal; and inputting the second driving signal to the display electrode.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic top view of pixel regions and non-pixel regions of a display substrate;

FIG. 2 is a schematic top view of a display substrate including optical sensing units;

FIG. 3 is a schematic cross-sectional view taken along line E-F in FIG. 2;

FIG. 4A is a schematic top view of the display substrate provided by an embodiment of the present disclosure;

FIG. 4B is a schematic top view of the display substrate provided by another embodiment of the present disclosure;

FIG. 4C is a schematic top view of the display substrate provided by another embodiment of the present disclosure;

FIG. 5 is a schematic cross-sectional view of the display substrate provided by an embodiment of the present disclosure (a schematic cross-sectional view taken along line J-K in FIG. 4A);

FIG. 6 is a schematic top view of the display substrate provided by an embodiment of the present disclosure;

FIG. 7A is a schematic cross-sectional view of the display substrate provided by an embodiment of the present disclosure (a schematic cross-sectional view taken along line M-N in FIG. 6);

FIG. 7B is a schematic cross-sectional view of the display substrate provided by another embodiment of the present disclosure (a schematic cross-sectional view taken along line U-V in FIG. 6);

FIG. 8 is a schematic cross-sectional view of optical sensing units in the display substrate provided by an embodiment of the present disclosure;

FIG. 9 is a schematic top view of a photosensitive layer in the display substrate provided by an embodiment of the present disclosure;

FIG. 10A is a schematic top view of a display substrate including a reflection layer, provided by an embodiment of the present disclosure (a schematic cross-sectional view taken along line M-N in FIG. 6);

FIG. 10B is a schematic top view of a display substrate including a reflection layer, provided by another embodiment of the present disclosure (a schematic cross-sectional view taken along line M-N in FIG. 6);

FIG. 10C is a schematic top view of a reflection layer in the display substrate provided by another embodiment of the present disclosure;

FIG. 11 is a schematic top view of a display substrate including a reflection layer, provided by an embodiment of the present disclosure (a schematic cross-sectional view taken along line U-V in FIG. 6);

FIG. 12A is a schematic cross-sectional view of the display device provided by an embodiment of the present disclosure;

FIG. 12B is a schematic cross-sectional view of the display device provided by another embodiment of the present disclosure;

FIG. 13 is a schematic cross-sectional view of the display device provided by another embodiment of the present disclosure;

FIG. 14 is a schematic diagram of a first driving circuit and a second driving circuit in the display device provided by an embodiment of the present disclosure;

FIG. 15 is a schematic diagram illustrating the case that each of the plurality of optical sensing units in the display device provided by an embodiment of the present disclosure is connected with the driving circuit through a signal transmission unit;

FIG. 16 is a schematic diagram illustrating the case that the optical sensing units and pixel regions in the display device provided by an embodiment of the present disclosure share a driving circuit; and

FIG. 17 is a schematic diagram of a signal receiving unit, a signal adjusting unit and a signal outputting unit in the display device provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

When the PPI of the display screen in the display product is constantly improved, the pixel area of the display product is constantly decreased and the aperture area is also continuously decreased, which becomes a greater challenge because pixels already have extremely small aperture ratio.

As for an optical signal sensor, in order to have good detection performance, the sensor may have a large photosensitive material coverage area, which is limited by smaller and smaller pixel space and aperture ratio.

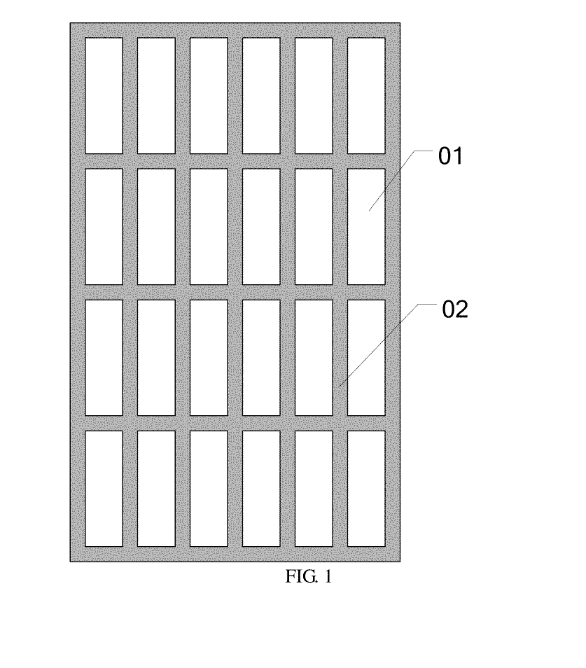

FIG. 1 illustrates a display substrate, which includes: a plurality of pixel regions 01 and a plurality of non-pixel regions 02. Each of the plurality of non-pixel regions 02 is located between adjacent pixel regions 01. For instance, each of the plurality of pixel regions 02 is a light-emitting area, and the non-pixel region 02 is a non-light-emitting area. As illustrated in FIG. 1, the plurality of non-pixel regions 02 are formed integrally. Description is given in FIG. 1 by taking rectangular pixel regions 01 as an example. The shape of the pixel region 01 and the non-pixel region 02 may be determined as required and are not limited to that as illustrated in FIG. 1.

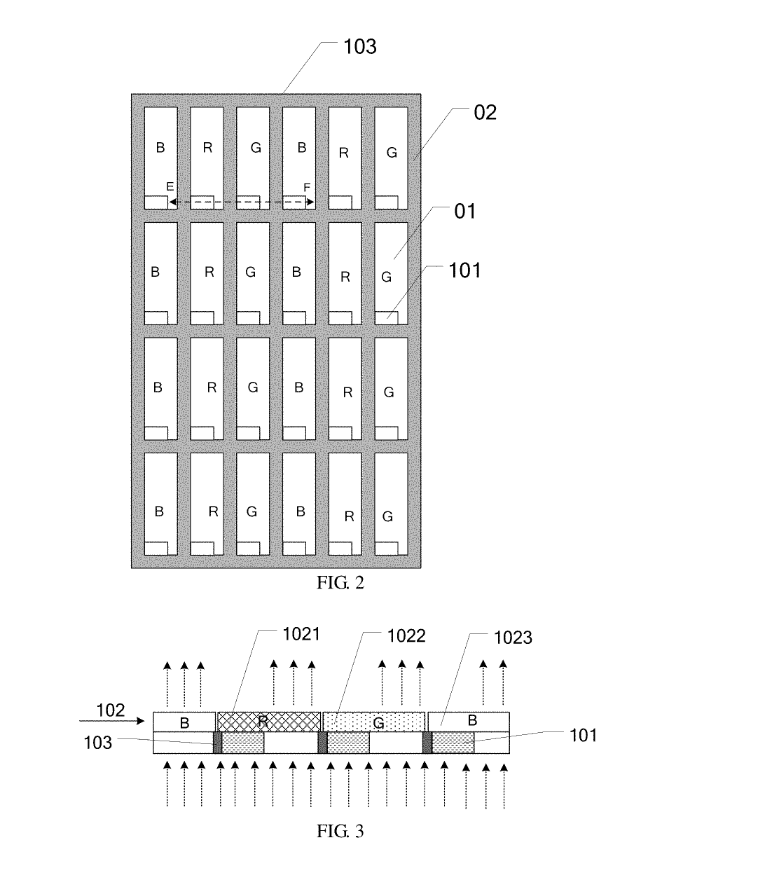

FIG. 2 illustrates a display substrate. Optical sensing units 101 are located in the pixel regions 01. FIG. 2 also illustrates that each pixel region 01 may be included in one sub-pixel. For instance, the sub-pixel may be a red sub-pixel, a green sub-pixel or a blue sub-pixel. A black matrix (BM) 103 is located in the non-pixel region 02, so as to achieve better color display. The plurality of optical sensing units 101 may be taken as a signal acquisition layer.

FIG. 3 is a cross-sectional view taken along line E-F in FIG. 2. As illustrated in FIGS. 2 and 3, because the optical sensing units 101 are located in the pixel regions 01 and light cannot be emitted or less light is emitted from positions provided with the optical sensing units 101, the optical sensing units 101 occupy the area of the pixel regions 01, so that the aperture ratio is reduced.

FIG. 3 also illustrates a color filter (CF) layer 102. When the display substrate includes the CF layer, the display substrate may be a CF substrate. For instance, as illustrated in FIG. 3, the CF layer 102 includes a red filter layer 1021, a green filter layer 1022 and a blue filter layer 1023. After light runs through an A CF layer, light of A color is emitted. A may be any primary color. For instance, red light is emitted after light runs through the red filter layer 1021; green light is emitted after the light runs through the green filter layer 1022; and blue light is emitted after the light runs through the blue filter layer 1023. Description is given in the embodiment of the present disclosure by taking the case that the CF layer 102 includes the red filter layer 1021, the green filter layer 1022 and the blue filter layer 1023 as an example, which is not limited thereto. For instance, the CF layer 102 may further include filter layers of other primary colors. For instance, the CF layer 102 may include filter layers of cyan (C), magenta (M) and yellow (Y), which is not limited thereto. For instance, the CF layer 102 may further include a white light layer, and a white sub-pixel is formed after light runs through the white light layer.

For general display devices, along with the improved PPI, the aperture ratio of a display region is significantly reduced, so the product is difficult to design. Moreover, as the detection area of optical signal is small, poor sensing characteristic can be easily caused.

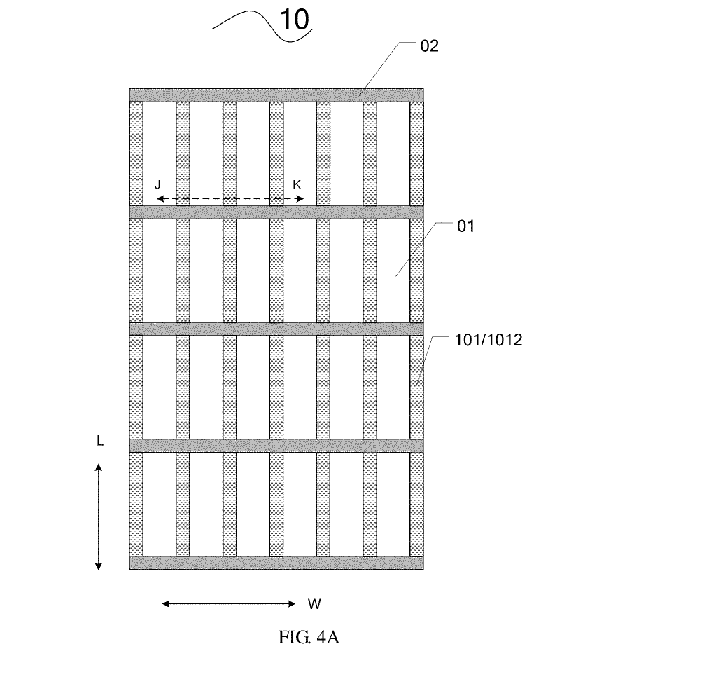

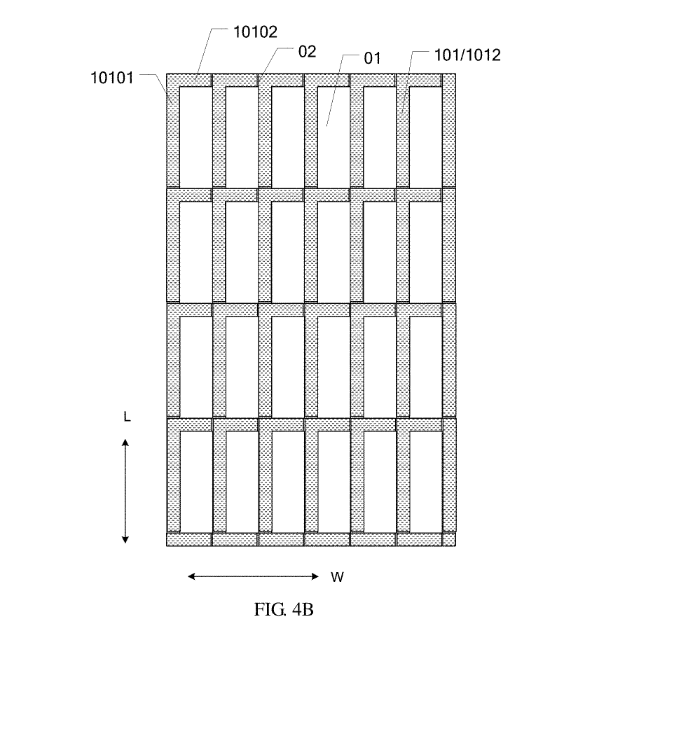

As illustrated in FIG. 4A, at least one embodiment of the present disclosure provides a display substrate 10, which includes: a plurality of pixel regions 01, a plurality of non-pixel regions 02 and a plurality of optical sensing units 101. Each of the plurality of non-display regions 02 is located between adjacent pixel regions 01. The plurality of optical sensing units 101 is located in the plurality of non-pixel regions 02. Each of the plurality of optical sensing units 101 is configured to receive light and output a sensing signal.

In the display substrate provided by at least one embodiment of the present disclosure, functional areas (optical sensing areas) are separated from the pixel regions, and the optical sensing units 101 are located in the plurality of non-pixel regions 02, so the optical sensing units 101 do not occupy the area of the pixel regions 02. Therefore, the aperture ratio of the pixel region 02 is not decreased, the transmittance of the display product is not reduced, a display device integrated with optical sensing units (such as optical sensors) and having high transmittance can be formed, thereby avoiding the loss of aperture ratio caused by the improved resolution of the display product and the integration of the functional areas.

For instance, the optical sensing units 101 include complementary metal oxide semiconductor (CMOS) elements, but are not limited thereto. For instance, the optical sensing units 101 may output signals respectively.

According to the display substrate provided by an embodiment of the present disclosure, each of the optical sensing units includes a photosensitive layer 1012. The photosensitive layer is configured to absorb light. The photosensitive layer is made of a photosensitive material. For instance, a pattern of the photosensitive layer 1012 may be the same as a pattern of the optical sensing unit 101 in FIG. 4A. For instance, a plurality of photosensitive layers 1012 of the plurality of optical sensing units 101 are independent of each other and not connected with each other, so as to facilitate the independent output of the signals.

As the optical sensing units 101 are located in the plurality of non-pixel regions, an area of the photosensitive layer 1012 in the optical sensing unit 101 can be increased. For instance, a material of the photosensitive layer 1012 includes semiconductor material, and moreover, for instance, includes amorphous silicon (a-Si), polysilicon (poly-Si), etc., but is not limited thereto. The poly-Si, for instance, may include low-temperature polysilicon (LTPS).

As illustrated in FIG. 4A, the pixel region 01 may include a length direction L and a width direction W, and the optical sensing unit 101 may be disposed along the length direction L of the pixel region 01. As the optical sensing unit 101 is located in the non-pixel region 02, a photosensitive material with large area may be set, so that the optical sensing unit 101 can have good sensing characteristic.

As illustrated in FIG. 4B, in order to further improve the area of the photosensitive material so that the optical sensing unit 101 can have good sensing characteristic, the optical sensing unit 101 may include a first part 10101 arranged along the length direction L of the pixel region 01 and a second part 10102 arranged along the width direction W of the pixel region 01, and the first part 10101 and the second part 10102 may be perpendicular to each other. In FIG. 4B, a plurality of photosensitive layers 1012 of the plurality of optical sensing units 101 are also independent of each other and not connected with each other.

As illustrated in FIGS. 4A and 4B, according to the display substrate provided by an embodiment of the present disclosure, the plurality of optical sensing units 101 are in a one-to-one correspondence with the plurality of pixel regions 01. Each pixel region 01 is provided with one optical sensing unit 101. Of course, the plurality of optical sensing units 101 may also be not in a one-to-one correspondence with the plurality of pixel regions 01.

As illustrated in FIG. 4C, according to the display substrate provided by an embodiment of the present disclosure, two adjacent pixel regions 01 may be provided with one optical sensing unit 101. In order to increase the area of the photosensitive layer of the optical sensing unit 101, the photosensitive layer of the optical sensing unit 101 may occupy most non-pixel region of a sub-pixel to which the photosensitive layer belongs. For instance, the photosensitive layer of the optical sensing unit 101 may occupy more than 80% of the area of the non-pixel region of the sub-pixel to which the photosensitive layer belongs. Moreover, for instance, the photosensitive layer of the optical sensing unit 101 may occupy more than 90% of the area of the non-pixel region of the sub-pixel to which the photosensitive layer belongs.

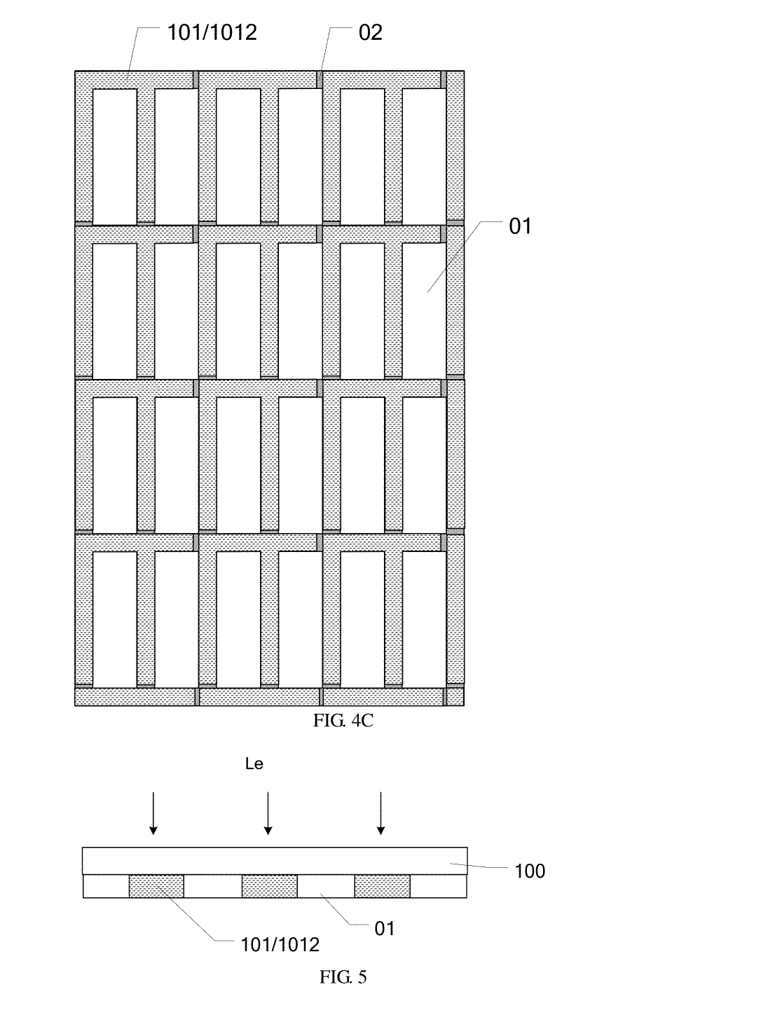

FIG. 5 is a cross-sectional view taken along line J-K in FIG. 4A. The display substrate includes a first base substrate 100. A plurality of optical sensing units 101 is located on the first base substrate 100. Each of the optical sensing units 101 may be configured to receive the irradiation of external light Le and output a sensing signal according to the received light. The sensing signal, for instance, is an electrical signal, and moreover, for instance, is a voltage or current signal. The external light Le, for instance, runs through the first base substrate 100 and is then irradiated on the optical sensing units 101. For instance, the sensing signals may be different according to different light intensity of the external light and may be changed according to a change in the light intensity of the external light.

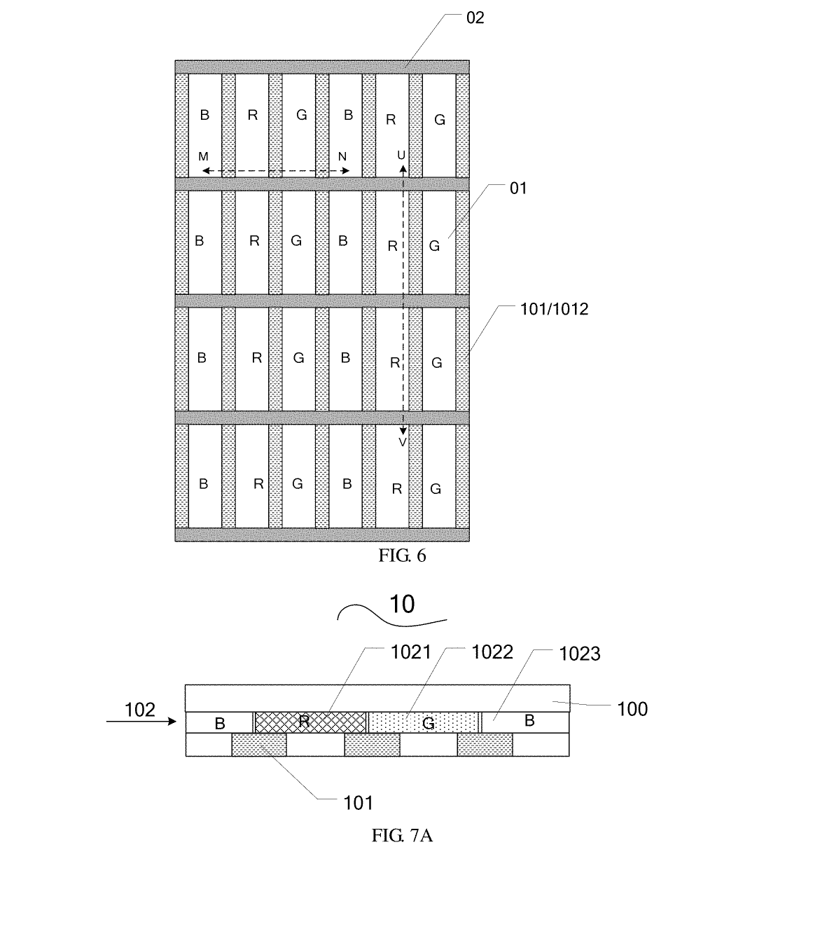

FIG. 6 illustrates a display substrate provided by an embodiment of the present disclosure, and each of the plurality of the pixel regions 01 is included in a sub-pixel. FIG. 6 takes sub-pixels including three primary colors of red, green and blue as an example. The optical sensing units 101 are located in the plurality of non-pixel regions 02. The arrangement of the optical sensing units 101 and the photosensitive layers 1012 thereof are not limited to those as illustrated in FIG. 6.

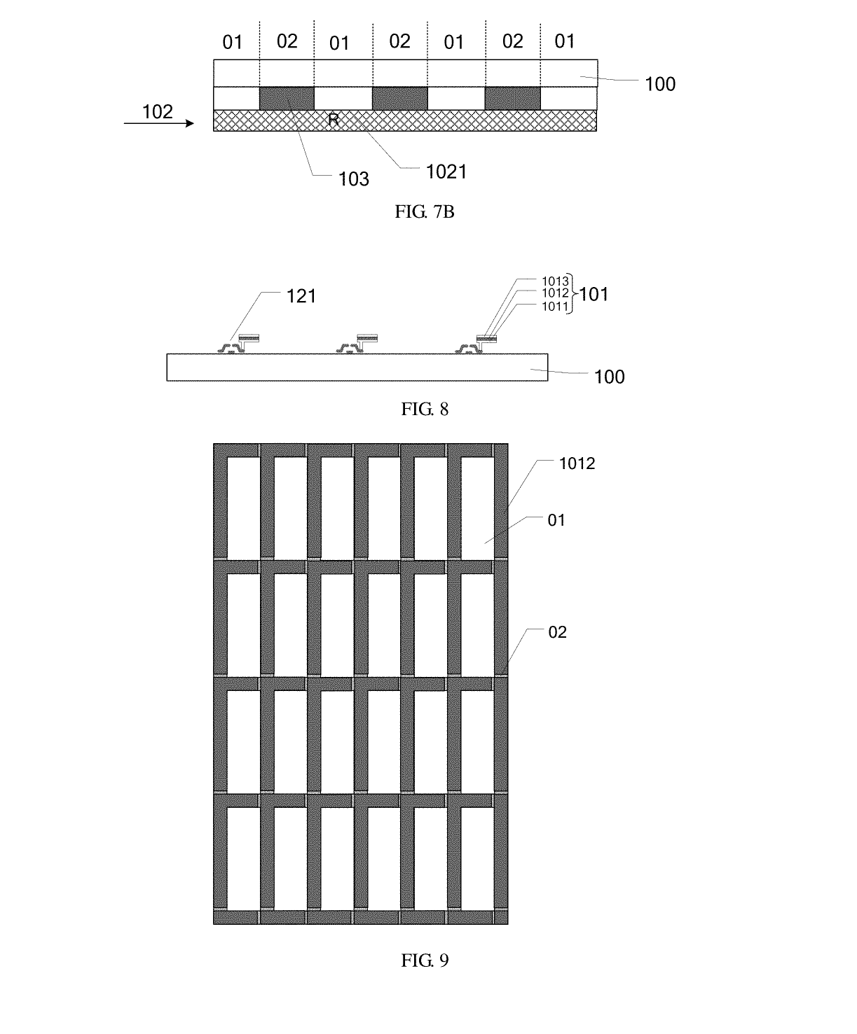

FIG. 7A is a cross-sectional view taken along line M-N in FIG. 6. According to the display substrate provided by an embodiment of the present disclosure, as illustrated in FIG. 7A, a CF layer 102 is located on the first base substrate 100, and a plurality of optical sensing units 101 are located on the CF layer 102. As described above, the CF layer 102 may include a red filter layer 1021, a green filter layer 1022 and a blue filter layer 1023. As the optical sensing unit includes the photosensitive layer 1012, the optical sensing unit 101 can absorb light irradiated thereon, can play the role of a BM, and can completely or partially replace the BM.

As illustrated in FIG. 7A, according to the display substrate provided by an embodiment of the present disclosure, the CF layer is located on a side of the plurality of optical sensing units 101 close to the first base substrate 100.

As illustrated in FIG. 7B, according to the display substrate provided by an embodiment of the present disclosure, a BM 103 may be further located at a position of the non-pixel region 02 not provided with photosensitive layer.

FIG. 8 illustrates a display substrate provided by an embodiment of the present disclosure, in which each of the optical sensing units 101 includes a first electrode 1011, a photosensitive layer 1012 and a second electrode 1013. For instance, one of the first electrode 1011 and the second electrode 1013 is a cathode and the other is an anode. For instance, the photosensitive layer 1012 may include a photosensitive material. For instance, the optical sensing unit 101 may include a PIN photosensitive diode.

As illustrated in FIG. 8, the first electrode 1011 of each optical sensing unit 101 may be electrically connected with a thin-film transistor (TFT) 121. For instance, at least one selected from the group consisting of the first electrode 1011 and the second electrode 1013 has the same pattern as the photosensitive layer 1012, which is not limited thereto. For instance, the first electrode 1011 and the second electrode 1013 may also have different patterns with the photosensitive layer 1012, as long as the first electrode and the second electrode are electrically connected with the photosensitive layer 1012 respectively.

For instance, the photosensitive layer 1012 may be interposed between the first electrode 1011 and the second electrode 1013, which is not limited thereto. For instance, in order to avoid the impact on light irradiated on the photosensitive layer, the first electrode 1011 and the second electrode 1013 may adopt transparent conductive materials, which is not limited thereto.

FIG. 9 is a schematic diagram of a photosensitive layer 1012 in the display substrate provided by an embodiment of the present disclosure. The photosensitive layer 1012 is located in the non-pixel region 02. For instance, the photosensitive layer 1012 may be arranged around the pixel region 01.

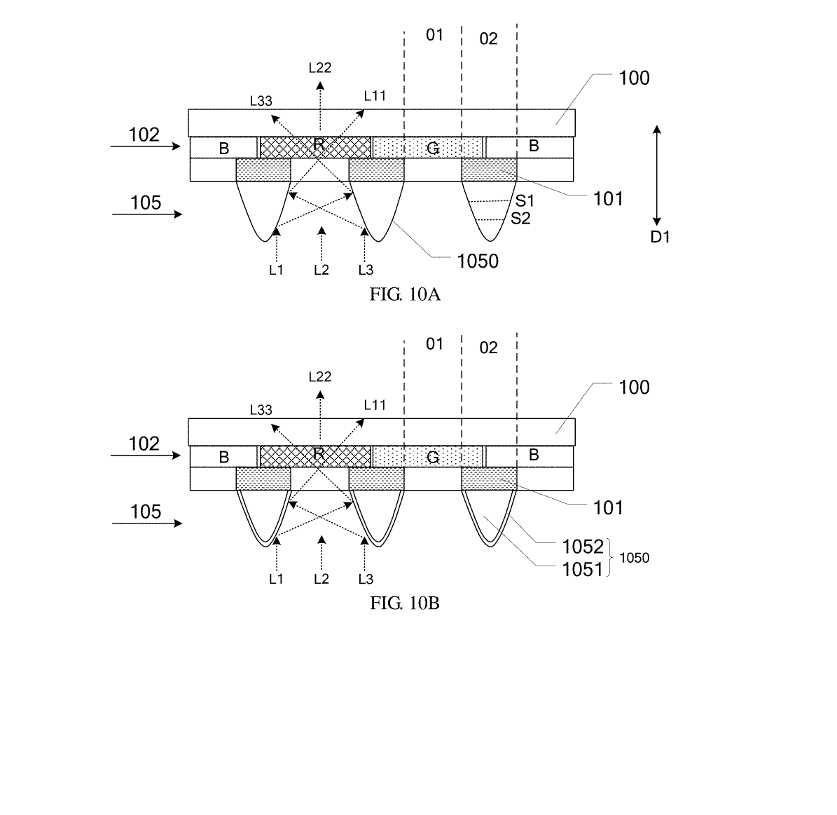

FIG. 10A illustrates a display substrate provided by an embodiment of the present disclosure. The display substrate further includes a reflection layer 105 located on the first base substrate 100. The reflection layer 105 is configured to reflect light irradiated thereon and located in the plurality of non-pixel regions 02. The plurality of optical sensing units 101 is closer to the first base substrate 100 than the reflection layer 105. The arrangement of the reflection layer 105 allows light irradiated on the reflection layer 105 to be emitted from the pixel region 01, so as to improve the light utilization rate, keep the brightness of the light emitted from each pixel region unchanged, and form a high-efficiency optical sensing display device. For instance, the reflection layer 105 is only located in the plurality of non-pixel regions 02. For instance, as illustrated in FIG. 10A, the reflection layer 105 includes a plurality of reflection elements 1050.

For instance, the arrangement of the reflection layer can also avoid the impact of light irradiated from a direction opposite to that of the external light (for instance, light emitted from a display panel or light of a backlight) on the optical sensing units, so that the detection result can be more accurate.

As illustrated in FIG. 10A, display light L1, L2 and L3 are irradiated on the reflection layer 105 and reflected by the reflection layer 105 and emitted from the pixel region 01, so as to improve the light utilization rate, keep the light emitted from the pixel region 01 not weakened, and maintain the brightness of light emitted from the sub-pixels unchanged. For instance, the reflection layer with this structure can be adopted to allow the light to run through an opening of a signal acquisition layer and can avoid the technical bottleneck of difficult integration of optical sensors in ultrahigh-resolution products.

As illustrated in FIG. 10A, according to the display substrate provided by an embodiment of the present disclosure, in order to realize total reflection on the reflection layer 105, in a direction from a position close to the first base substrate 100 to a position away from the first base substrate 100, an area of a cross-section of each of the reflection elements 1050 in a direction parallel with the first base substrate 100 is gradually decreased. For instance, in a direction D1 perpendicular to the first base substrate 100, a cross-section S1 of the reflection element 1050 which is parallel with the first base substrate 100 and close to the first base substrate 100 is greater than a cross-section S2 of the reflection element which is parallel with the first base substrate 100 and away from the first base substrate 100. For instance, the light irradiated on the reflection layer 105 can be totally reflected. For instance, light irradiated on the reflection elements 1050 on two sides of the same pixel region can be emitted after at least one total reflection. FIG. 10A illustrates the case that the light irradiated on the reflection elements on two sides of the same pixel region is emitted after two total reflections. The fewer the total number of total reflections, the more favorable.

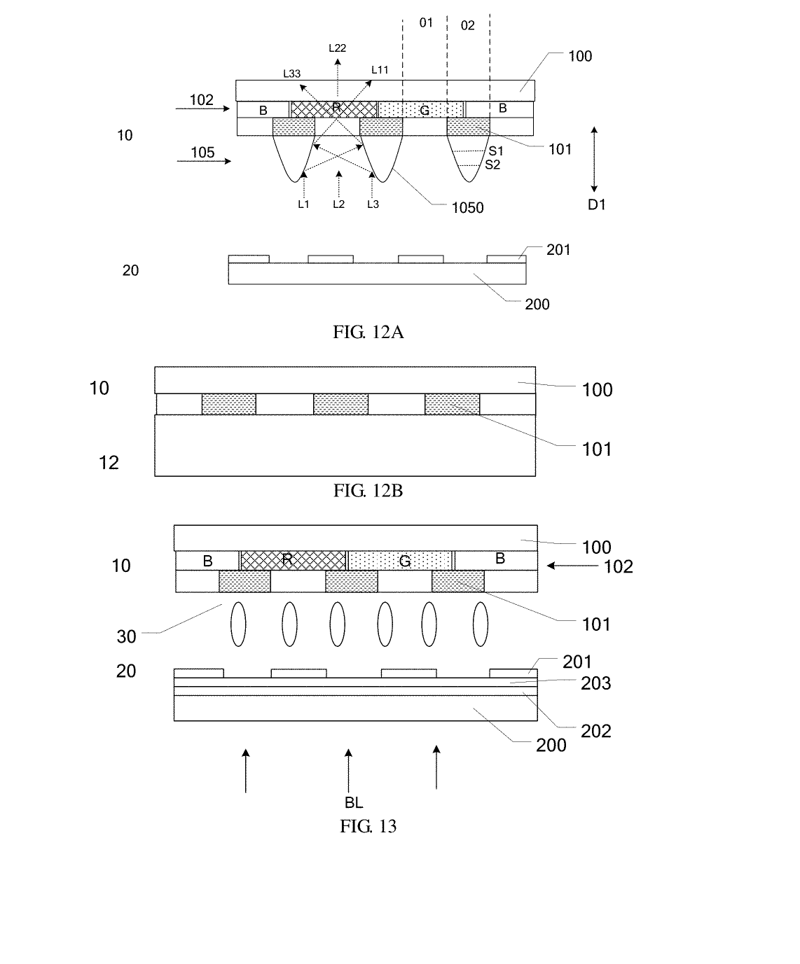

When the display mode is started, light of a backlight arrives at the reflection layer 105 after running through a control layer with switching function (e.g., TFT elements and pixel electrodes). For instance, the control layer with switching function may be located on a second base substrate 200 (the second base substrate 200 may refer to FIG. 12A) on a position opposite to the display substrate 10 (may refer to FIG. 7A). For instance, the reflection layer may be designed according to the incident angle and the emergence angle of the light, and finally the total reflection effect can be achieved. For instance, the reflection layer 105 may be made of a material with total reflection effect. Color images are displayed after the light finally runs through the aperture area.

As illustrated in FIG. 10 A, according to the display substrate provided by an embodiment of the present disclosure, in order to realize total reflection on the reflection layer 105, in the direction D1 perpendicular to the first base substrate 100, a cross-section of each of the reflection elements 1050 includes a curved or parabolic part. For instance, as illustrated in FIG. 10A, in the direction from a position close to the first base substrate 100 to a position away from the first base substrate 100 (in the direction from the up and down direction), a distance between adjacent reflection elements 1050 is gradually increased.

As illustrated in FIG. 10A, according to the display substrate provided by an embodiment of the present disclosure, in the direction D1 perpendicular to the first base substrate 100, the reflection layer 105 and the plurality of optical sensing units 101 are at least partially overlapped.

As illustrated in FIG. 10B, according to the display substrate provided by an embodiment of the present disclosure, the reflection element 1050 may include a reflection body layer 1051 and a total reflection layer 1052 coated on the reflection body layer. The total reflection layer 1052 can enhance the reflectivity to light. For instance, the total reflection layer 1052 has total reflection effect. For instance, the total reflection layer may adopt silver (Ag). For instance, the reflection body layer 1051 may not have total reflection effect.

For instance, the reflection layer 105 may be provided with microstructures corresponding to the non-pixel regions by a nanoimprinting process.

For instance, as illustrated in FIG. 10C, the reflection layer 105 may be arranged around the pixel regions 01, and a pattern of the reflection layer 105 may be the same as a pattern of the non-pixel regions 02 and includes a grating part. For instance, each of the plurality of pixel regions 01 may be encircled by the reflection layer 105.

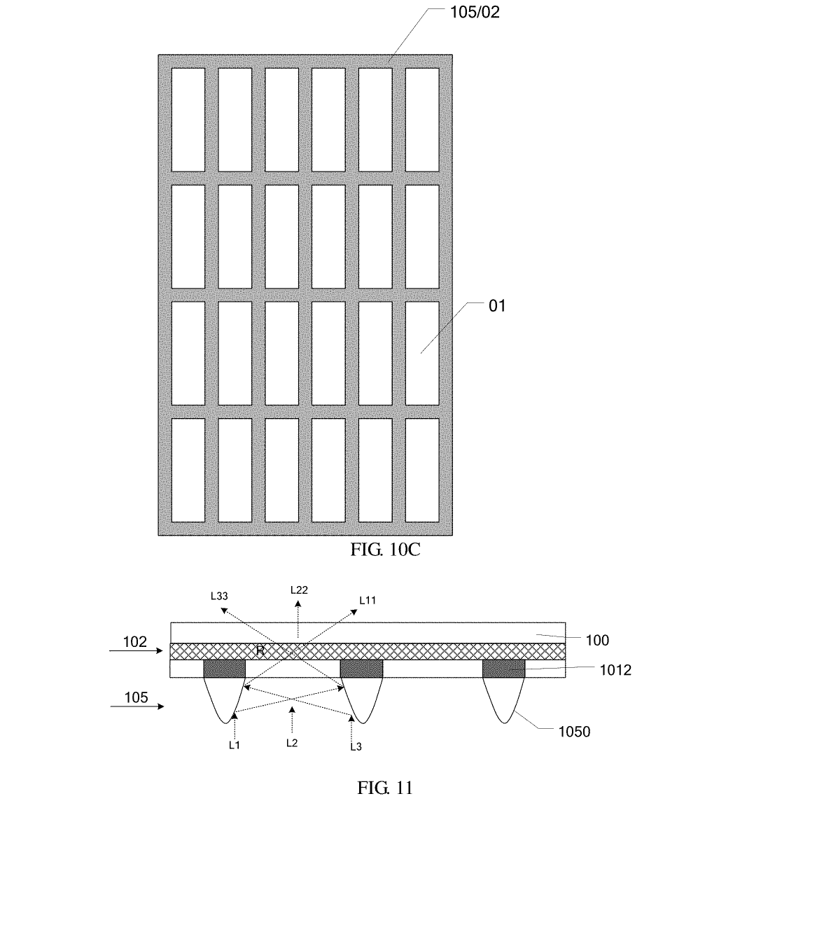

FIG. 11 illustrates a display substrate provided by an embodiment (a cross-sectional view taken along line U-V in FIG. 6). When sub-pixels of the same color are located in the same direction, filter layers of the same color may be extended along the same direction. For instance, when the sub-pixels of the same color are located in the same column, the filter layers of the same color may be extended along the column direction.

For instance, the first base substrate 100 is a transparent substrate. For instance, a material of the first base substrate 100 includes glass or resin, but is not limited thereto.

As illustrated in FIG. 12A, at least one embodiment of the present disclosure provides a display device, which includes another display substrate (a second display substrate) 20 and any foregoing display substrate 10. The second display substrate 20 includes a second base substrate 200; the second display substrate 20/the second base substrate 200 is disposed opposite to the display substrate 10; a plurality of mutually insulated display electrodes 201 are also located on a side of the second base substrate 200 close to the display substrate 10; and the plurality of optical sensing units 101 is not overlapped with the plurality of display electrodes 201 in the direction D1 perpendicular to the first base substrate 100. For instance, an orthographic projection of the plurality of optical sensing units 101 on the first base substrate 100 is not overlapped with an orthographic projection of the plurality of display electrodes 201 on the first base substrate 100. The second display substrate 20, for instance, may be an array substrate. The plurality of display electrodes 201 may be taken as a light switch control layer and may control light irradiated on the display panel (the pixel regions). For instance, each display electrode 201 may also be connected with a TFT, so as to facilitate signal input. For instance, the display electrode 201 may be a pixel electrode.

For instance, the display electrode 201 may be only located in the pixel region 01, which is not limited thereto. For instance, in order to improve the display effect, the display electrode 201 may further include a part located in the non-pixel region 02 apart from a part located in the pixel region 01. For instance, as illustrated in FIG. 12A, the plurality of display electrodes 201 may be in one-to-one correspondence with the plurality of pixel regions, which is not limited thereto.

For instance, the second base substrate 200 is a transparent substrate. For instance, a material of the second base substrate 200 includes glass or resin, but is not limited thereto.

For instance, the display device provided by at least one embodiment of the present disclosure can realize the integration in pixels with ultrahigh PPI by the independent design of the signal acquisition layer (optical sensing units) and a display layer (the display layer is formed by the plurality of display electrodes 201).

As illustrated in FIG. 12A, according to the display device provided by an embodiment of the present disclosure, the reflection layer 105 and the plurality of optical sensing units 101 are disposed on a side of the first base substrate 100 close to the second base substrate 200.

For instance, the display device may include a liquid crystal display (LCD) device or an organic light-emitting diode (OLED) display device. For instance, the display substrate 10 may be taken as a substrate of the display device, or the display substrate 10 may be disposed on the display panel.

FIG. 12B illustrates a display device provided by an embodiment of the present disclosure. For instance, the display substrate 10 may be combined with a display panel 12 by bonding or other processes. For instance, the mode of independent design of the functional layers and the display panel is applicable to products with ultrahigh PPI demand.

As illustrated in FIG. 13, according to the display device provided by an embodiment of the present disclosure, the display device is an LCD device. The display device includes a liquid crystal layer 30, and a common electrode 202 is further disposed on the second base substrate 200. The common electrode 202 may be in a plate shape. A multidimensional electric field may be formed between the plurality of display electrodes 201 and the common electrode 202 to drive liquid crystal molecules in the liquid crystal layer 30 to rotate, so as to achieve display. An insulation layer 203 may be located between the display electrodes 201 and the common electrode 202. It should be noted that the setting mode of the common electrode 202 and the plurality of display electrodes 201 is not limited to that as illustrated in FIG. 13 and may be adjusted as required. For instance, the common electrode 202 may be disposed on the first base substrate 100. FIG. 13 also illustrates a backlight BL. The backlight BL for display may be provided by a backlight source. The backlight source, for instance, includes a collimated light source. For instance, light may be reflected by the reflection layer located in the plurality of non-pixel regions 02 and then run through the pixel regions 01.

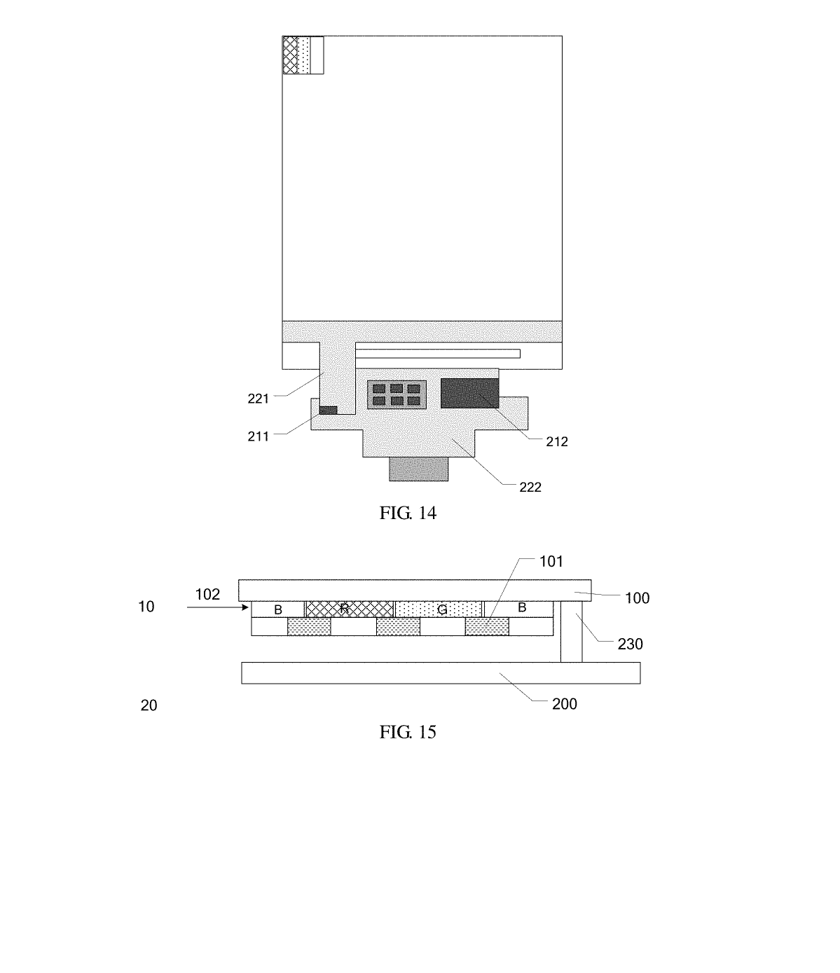

As illustrated in FIG. 14, the display device, provided by an embodiment of the present disclosure, further includes a first driving circuit 211 and a second driving circuit 212. The first driving circuit 211 is configured to receive sensing signals. The second driving circuit 212 is configured to adjust driving signals inputted into the plurality of display electrodes 201 according to the sensing signals. Thus, real-time adjustment may be made according to the change of external light. As illustrated in FIG. 14, the plurality of optical sensing units 101 may be electrically connected with the first driving circuit 211 through a first flexible printed circuit board (FPC) 221. The first driving circuit 211 may be electrically connected with the second driving circuit 212 through a second FPC 222. The plurality of display electrodes 201 may be electrically connected with the second driving circuit 212 through the second FPC 222. For instance, the second driving circuit 212 is an integrated circuit (IC) for display regions. For instance, the second driving circuit 212 is configured to input adjusted driving signals to the plurality of display electrodes 201.

As illustrated in FIG. 15, a conductive signal transmission unit 230 may be further disposed in non-display region of the display panel to transmit collected optical signal to an integrated circuit (IC) for display regions, so as to share the same IC. For instance, the signal transmission unit 230 includes a silver adhesive point, but is not limited thereto.

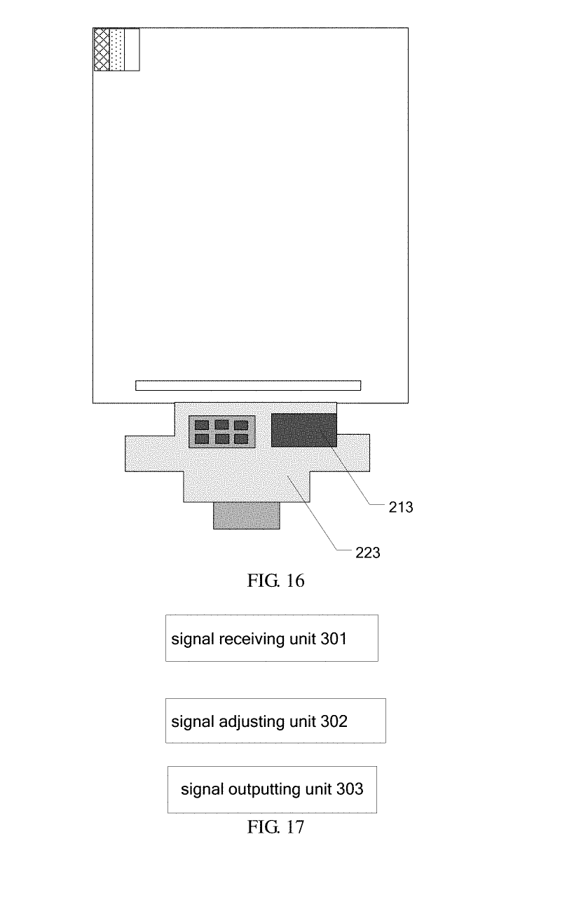

As illustrated in FIG. 16, according to the display device provided by an embodiment of the present disclosure, the plurality of optical sensing units 101 may be electrically connected with an FPC 223 and a driving circuit 213 through the signal transmission units 230 (as illustrated in FIG. 15) respectively. That is to say, the first driving circuit 211 and the second driving circuit 212 are integrated together to form the driving circuit 213.

For instance, when the signal acquisition mode is started, light runs through the CF layer and is subsequently acquired by the photosensitive materials of the optical sensing units 101, and signals are transmitted to the driving circuit (IC) through a photoelectric conversion unit (such as optical sensing units) to realize signal acquisition.

At least one embodiment of the present disclosure provides a method for driving any foregoing display device, which includes: receiving the sensing signal outputted by the optical sensing unit 101; adjusting a first driving signal, to be inputted into the display electrode 201 of the pixel region to which the optical sensing unit outputting the sensing signal belongs, into a second driving signal according to the sensing signal; and inputting the second driving signal to the display electrode 201.

Therefore, the driving signals inputted into the plurality of display electrodes may be adjusted in real time according to the change in the external light, so as to achieve better display effect.

As illustrated in FIG. 17, the display device provided by an embodiment of the present disclosure may include a signal receiving unit 301, a signal adjusting unit 302 and a signal outputting unit 303. The signal receiving unit is configured to receive the sensing signal. The signal adjusting unit is configured to adjust a first driving signal, to be inputted into the display electrode of the pixel region to which the optical sensing unit outputting the sensing signal belongs, into a second driving signal according to the sensing signal. The signal outputting unit is configured to input the second driving signal into the display electrode.

The display device provided by the embodiment of the present disclosure may further include one or more processors and one or more memories. The processor may process data signals and may include various computing structures such as a complex instruction set computer (CISC) architecture, a structured reduced instruction set computer (RISC) architecture, or an architecture for implementing a combination of multiple instruction sets. The memory may store instructions and/or data executed by the processor. These instructions and/or data may include codes which are configured to achieve some functions or all the functions of one or more components, units and devices provided by the embodiment of the present disclosure. For instance, the memory includes a dynamic random access memory (DRAM), a static random access memory (SRAM), a flash memory, an optical memory or other memories well known to those skilled in the art.

In some embodiments of the present disclosure, the display device may include codes and programs stored in the memory; and the processors may execute the codes and the programs so as to realize some functions or all the functions of the above components, units and display devices.

In some embodiments of the present disclosure, the signal receiving unit, the signal adjusting unit and the signal outputting unit may be hardware devices and configured to realize some or all the functions of the above components and units. For instance, the signal receiving unit, the signal adjusting unit and the signal outputting unit may be one circuit board or a combination of a plurality of circuit boards and are configured to realize the above functions. In the embodiment of the present disclosure, the one circuit board or the combination of the plurality of circuit boards may include: (1) one or more processors; (2) one or more non-transitory computer-readable memories connected with the processors; and (3) processor-executable firmware stored in the memories.

For instance, some or all the functions of the signal receiving unit, the signal adjusting unit and the signal outputting unit may be realized by software, hardware, firmware or any combination means thereof.

In an embodiment, the display device includes a processor, a memory and computer program instructions stored in the memory. The computer program instructions are executed by the processor to cause the processor to: receiving the sensing signal outputted by the optical sensing unit; adjusting a first driving signal, to be inputted into the display electrode of the pixel region to which the optical sensing unit outputting the sensing signal belongs, into a second driving signal according to the sensing signal; and inputting the second driving signal to the display electrode.

Description is given to the manufacturing method by taking the forming of a thin-film transistor liquid crystal display (TFT-LCD) as an example.

For instance, the manufacturing process of the display panel in the above display device is the same as the manufacturing process of the array substrate of the conventional display device such as the TFT-LCD. The manufacturing process of the display substrate 10 is as follows.

(1) Selecting glass or transparent resin to form a first base substrate.

(2) Forming a plurality of optical sensing units on the first base substrate.

(3) Coating a micro-nano structural film layer on the first base substrate. A material of the micro-nano structural film layer, for instance, includes polyimide (PI), etc.

(4) Forming a micro-nano structural layer with a reflection structure by a nanoimprint process according to the size of sub-pixels on the display panel. For instance, these micro-nano structures are arranged in the same cycle as the sub-pixels. For instance, the surface tilt angle of the micro-nano structural layer is designed according to a specific optical path, so that the light can pass completely without causing loss of light efficiency.

(5) Coating a total reflection material layer (e.g., Ag) on the micro-nano structural layer if required, so as to enhance the reflectivity of light.

(6) Coating a CF layer on the first base substrate to realize color display. For instance, a planarization layer may also be formed before the forming of the CF layer, which is not limited thereto. For instance, the CF layer may be formed before the forming of the plurality of optical sensing units.

(7) Forming the display device by bonding the formed display substrate provided with the functional layers to the display panel. The display panel may be not provided with the CF layer. When the display substrate 10 is not provided with the CF layer, the CF layer may be located in the display panel.

It should be noted that, for the purpose of clarity only, in accompanying drawings for illustrating the embodiment(s) of the present disclosure, the thickness and size of a layer or a structure may be enlarged. However, it should understood that, in the case in which a component or element such as a layer, film, area, substrate or the like is referred to be “on” or “under” another component or element, it may be directly on or under the another component or element or a component or element is interposed therebetween.

In case of no conflict, features in one embodiment or in different embodiments can be combined.

What have been described above are only specific implementations of the present disclosure, the protection scope of the present disclosure is not limited thereto. Any changes or substitutions easily occur to those skilled in the art within the technical scope of the present disclosure should be covered in the protection scope of the present disclosure. Therefore, the protection scope of the present disclosure should be based on the protection scope of the claims.

What is claimed is:

1. A display substrate, comprising:
a plurality of pixel regions;
a plurality of non-pixel regions, each of the plurality of non-pixel regions being located between adjacent pixel regions; and
a plurality of optical sensing units located in the plurality of non-pixel regions, each of the plurality of optical sensing units being configured to receive light and output a sensing signal.

2. The display substrate according to claim 1, wherein the optical sensing unit comprises a photosensitive layer configured to absorb the light.

3. The display substrate according to claim 1, further comprising a first base substrate and a reflection layer, wherein the reflection layer and the plurality of optical sensing units are disposed on the first base substrate; the reflection layer is configured to reflect light irradiated thereon and located in the plurality of non-pixel regions; and the plurality of optical sensing units are closer to the first base substrate than the reflection layer.

4. The display substrate according to claim 3, wherein the reflection layer comprises a plurality of reflection elements; and an area of a cross-section of each of the reflection elements in a direction parallel with the first base substrate is gradually decreased in a direction from a position close to the first base substrate to a position away from the first base substrate.

5. The display substrate according to claim 4, wherein a cross-section of each of the reflection elements in a direction perpendicular to the first base substrate comprises a curved or parabolic part.

6. The display substrate according to claim 3, wherein the reflection layer comprises a plurality of reflection elements; and in a direction perpendicular to the first base substrate, an area of a cross-section parallel with the first base substrate of each of the reflection elements close to the first base substrate is greater than an area of a cross-section parallel with the first base substrate of the reflection element away from the first base substrate.

7. The display substrate according to claim 3, wherein the reflection layer comprises a plurality of reflection elements; and a distance between adjacent reflection elements is gradually increased in a direction from a position close to the first base substrate to a position away from the first base substrate.

8. The display substrate according to claim 3, wherein the reflection layer and the plurality of optical sensing units are at least partially overlapped with each other in a direction perpendicular to the first base substrate.

9. The display substrate according to claim 3, wherein the plurality of optical sensing units are in a one-to-one correspondence with the plurality of pixel regions.

10. The display substrate according to claim 1, further comprising a first base substrate and a color filter (CF) layer, wherein the plurality of optical sensing units and the CF layer are disposed on the first base substrate, and the CF layer is located on a side of the plurality of optical sensing units close to the first base substrate.

11. A display device, comprising a second base substrate and the display substrate according to claim 1, wherein the second base substrate is disposed opposite to the display substrate; and a plurality of mutually insulated display electrodes are further provided on a side of the second base substrate close to the display substrate.

12. The display device according to claim 11, wherein each of the optical sensing units corresponds to at least one display electrode.

13. The display device according to claim 11, further comprising a signal receiving unit, a signal adjusting unit and a signal outputting unit, wherein the signal receiving unit is configured to receive the sensing signal; the signal adjusting unit is configured to adjust a first driving signal, to be inputted into the display electrode of the pixel region to which the optical sensing unit outputting the sensing signal belongs, into a second driving signal according to the sensing signal; and the signal outputting unit is configured to input the second driving signal to the display electrode.

14. A method for driving a display device, the display device comprising a second base substrate and a display substrate; the display substrate comprising: a plurality of pixel regions, a plurality of non-pixel regions and a plurality of optical sensing units; each of the plurality of non-pixel regions being located between adjacent pixel regions; the plurality of optical sensing units being located in the plurality of non-pixel regions; each of the plurality of optical sensing units being configured to receive light and output a sensing signal;
the second base substrate being disposed opposite to the display substrate; a plurality of mutually insulated display electrodes being further provided on a side of the second base substrate close to the display substrate;
the method comprising:
receiving the sensing signal outputted by the optical sensing unit;
adjusting a first driving signal, to be inputted into the display electrode of the pixel region to which the optical sensing unit outputting the sensing signal belongs, into a second driving signal according to the sensing signal; and
inputting the second driving signal to the display electrode.
